(19) United States
(12) Patent Application Publication
(10) Pub. No.: US 2006/0125724 A1
(43) Pub. Date: Jun. 15, 2006

(54) Plasma display device and driving method thereof

(76) Inventor: Joo-Yul Lee, Suwon-si (KR)

Correspondence Address: CHRISTIE, PARKER & HALE, LLP, PO BOX 7068, PASADENA, CA, 91109-7068, US

(21) Appl. No.: 11/298,096

(22) Filed: Dec. 8, 2005

(30) Foreign Application Priority Data
Dec. 13, 2004 (KR) 10-2004-0104832

(51) Int. Cl. G09G 3/28

(52) U.S. Cl. 345/63

(57) ABSTRACT

A plasma display device and a driving method thereof. The plasma display device has a vertical synchronization signal of a second frequency lower than a first frequency, and is driven by a frame divided into a plurality of subfields having respective weight values. In an address period, the device sequentially applies a scan pulse to the first electrode and applies an address pulse to the third electrode of a discharge cell to be turned on among the plurality of discharge cells formed on the first electrode to which the scan pulse is applied. At least a part of a difference between one frame time according to the first frequency and that according to the second frequency is allocated to an address pulse width. Flicker is reduced and a stable address discharge is made in the Phase Alternate Line (PAL) driving scheme.

### CROSS-REFERENCE TO RELATED APPLICATION

This application claims priority to and the benefit of Korean Patent Application No. 10-2004-0104832 filed in the Korean Intellectual Property Office on Dec. 13, 2004, the entire content of which is incorporated herein by reference.

### BACKGROUND OF THE INVENTION

1. Field of the Invention

The present invention relates to a plasma display device and a driving method thereof.

2. Description of the Related Art

A plasma display panel (PDP) is a flat panel display that uses plasma generated by gas discharge to display characters or images. It includes, depending on its size, more than several scores to millions of pixels arranged in a matrix pattern.

FIG. 1 illustrates a conventional arrangement of subfields which form a frame. In FIG. 1, one frame is divided into eight subfields SF1 to SF8.

As shown in FIG. 1, the plasma display device is driven by a plurality of subfields of a frame, and have respective brightness weight values. Each subfield has an address period A1 to A8, and a sustain period S1 to S8.

Among the eight subfields SF1 to SF8, a discharge cell is to be turned on in some subfields. A sum of weights of these subfields determines a grayscale of the discharge cell to be turned on. As shown in FIG. 1, subfields SF1 to SF8 are arranged in increasing order of weight or in decreasing order of weight.

The address periods A1 to A8 are for selecting turn-on/turn-off cells (i.e., cells to be turned on or off). The sustain periods S1 to S8 are for causing a discharge for actually displaying an image on the addressed cells. Here, lengths of the sustain periods S1 to S8 correspond to the weights of the subfields SF1 to SF8, and in FIG. 1, it is assumed that the lengths of the sustain periods S1 to S8 are respectively 1T, 2T, 4T, 8T, 16T, 32T, 64T, and 128T. In addition, before the address periods A1 to A8, a reset period (not shown) for initializing the discharge cell can be provided.

Generally, in the National Television System Committee (NTSC) scheme, a time for a frame is 16.67 ms (= 1/60 sec) because a display device is operated at a frequency of 60 Hz, while in the Phase Alternate Line (PAL) scheme, a time for a frame is 20 ms (= 1/50 sec) because a display device is operated at a frequency of 50 Hz.

Because the time for a frame is relatively long in the PAL scheme, the human eye can recognize a frame when the arrangement of the subfields is as in FIG. 1, and will therefore perceive an image flicker. In other words, a flicker phenomenon may occur in the PAL scheme. In FIG. 1, since a subfield of the largest weight value, which is recognized to be the brightest, is arranged at the end of a frame, a person can perceive a change of image every 20 ms. However, since this time interval can be recognized by the human eye, an image being displayed is actually seen to flicker.

In the address period, since a scan pulse having a fixed width is sequentially applied to all scan electrodes, a fixed time needs to be allocated to the address period. However, because the time for a frame is limited, a time for the address period is decreased, and so an address operation may not be performed properly.

### SUMMARY OF THE INVENTION

In accordance with the present invention a plasma display device and a driving method thereof is provided for reducing flicker in the PAL scheme and for enabling a stable address discharge.

An exemplary driving method of a plasma display panel according to an embodiment of the present invention drives the plasma display panel by a frame divided into a plurality of subfields having respective weight values. Here, the plasma display panel includes a plurality of first electrodes, a plurality of second electrodes, and a plurality of third electrodes formed in a direction crossing the first and second electrodes, and has a vertical synchronization signal of a second frequency lower than a first frequency. The method includes the steps below.

First, a scan pulse is sequentially applied to the first electrode.

Then, an address pulse is applied to the third electrode of a discharge cell to be turned on among the plurality of discharge cells formed on the first electrode to which the scan pulse is applied.

Here, at least a part of a difference between one frame time according to the first frequency and that according to the second frequency is allocated to an address pulse width.

In a further embodiment, the first frequency is a vertical synchronization frequency of the NTSC scheme and the second frequency is a vertical synchronization frequency of the PAL scheme.

In a still further embodiment, the one frame is divided into at least a first group and a second group, and wherein the plurality of subfields are alternatingly distributed to the first group and second group in order of weight value magnitude.

An exemplary plasma display device according to an embodiment of the present invention includes a plasma display panel, a controller, and a driving circuit.

The plasma display panel includes a plurality of first electrodes, a plurality of second electrodes, and a plurality of third electrodes formed in a direction crossing the first and second electrodes.

The controller divides a frame into a plurality of subfields including a reset period, an address period, and a sustain period. In an extrinsic vertical synchronization signal of a second frequency lower than a first frequency, the controller allocates at least a part of a difference between one frame time according to the first frequency and one frame time according to the second frequency to a width of an address pulse which is applied to the third electrode of a discharge cell to be selected in the address period.

The driving circuit respectively applies a scan pulse and the address pulse to the first electrode and the third electrode of the discharge cell to be selected in the address period.

In a further embodiment, the first frequency is a vertical synchronization frequency of the NTSC scheme and the second frequency is a vertical synchronization frequency of the PAL scheme.

In a still further embodiment, the controller divides the one frame into a at least a first group and a second group and alternatingly distributes the plurality of subfields to the first group and the second group in order of weight value magnitude.

### BRIEF DESCRIPTION OF THE DRAWINGS

FIG. 1 illustrates a conventional arrangement of subfields of a frame.

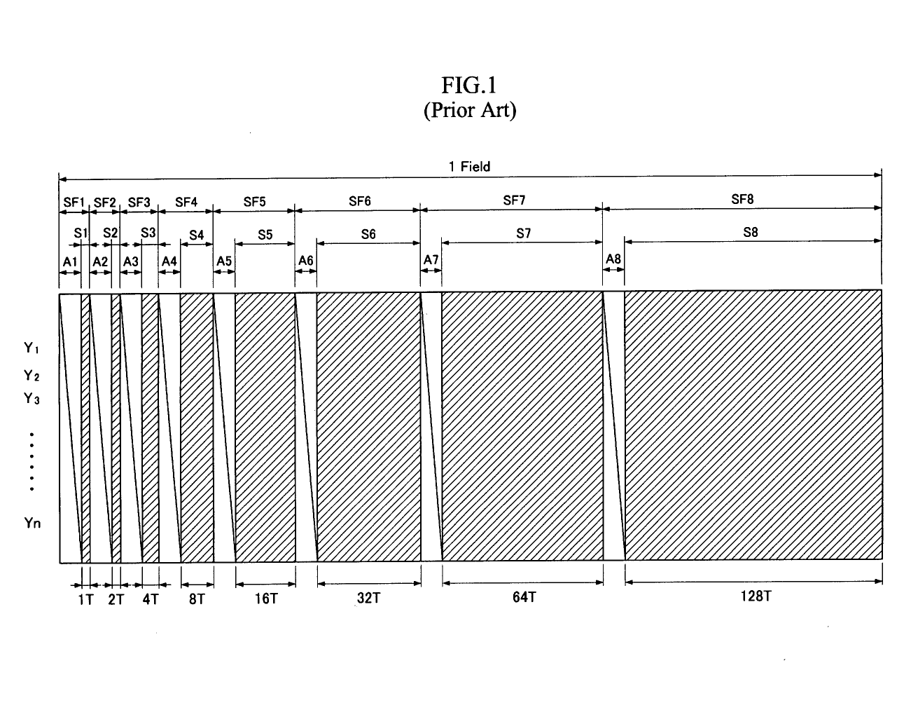

FIG. 2 is a block diagram showing a plasma display device according to a first exemplary embodiment of the present invention.

FIG. 3 illustrates a subfield arrangement in the PAL scheme according to the first exemplary embodiment of the present invention.

FIG. 4 illustrates a subfield arrangement in the PAL scheme according to a second exemplary embodiment of the present invention.

FIG. 5 illustrates a driving waveform for the subfield shown in FIG. 4.

### DETAILED DESCRIPTION OF THE EMBODIMENTS

A wall charge mentioned in accordance with the present invention means charges formed and accumulated on a wall (e.g., a dielectric layer) close to an electrode of a discharge cell. Although the wall charges do not actually touch the electrodes, herein the wall charge will be described as being “formed” or “accumulated” on the electrode. A wall voltage means a potential difference formed on a wall of a cell by the wall charge.

Hereinafter, a plasma display device and a driving method thereof according to exemplary embodiments of the present invention will be described in detail.

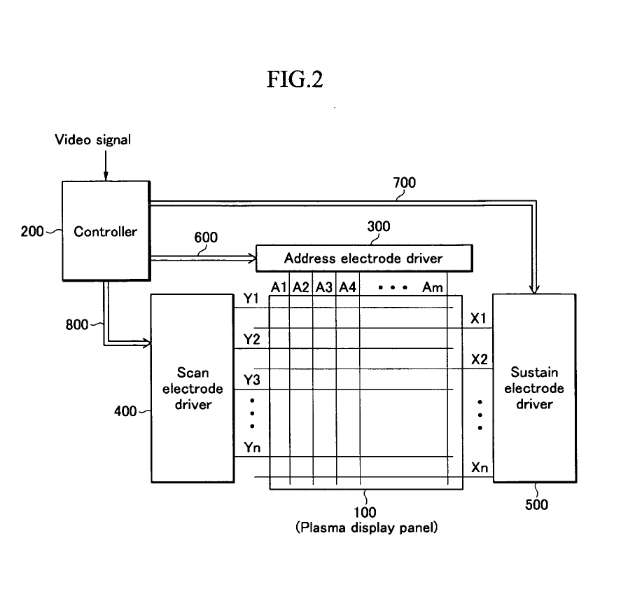

Referring now to FIG. 2, a structure of the plasma display device according to the first exemplary embodiment of the present invention will be described in detail. The plasma display device includes a PDP 100, a controller 200, an address electrode driver 300, a scan electrode driver 400, and a sustain electrode driver 500.

The PDP 100 includes a plurality of address electrodes A1 to Am extended in the column direction, and pluralities of sustain electrodes X1 to Xn and scan electrodes Y1 to Yn that are extended in the row direction in pairs. Generally, the sustain electrodes X1 to Xn are formed in correspondence with the respective scan electrodes Y1 to Yn. The PDP 100 includes a substrate in which the sustain and scan electrodes (i.e., X1 to Xn, Y1 to Yn) are arranged (not shown), and another substrate in which the address electrodes A1 to Am are arranged (not shown). The two substrates are placed facing each other with a discharge space therebetween so that the scan electrodes Y1 to Yn and the address electrodes A1 to Am may perpendicularly cross each other, and the sustain electrodes X1 to Xn and the address electrodes A1 to Am may perpendicularly cross each other. Here, the discharge space formed at a crossing region of the address electrodes A1 to Am and the sustain and scan electrodes X1 to Xn, and Y1 to Yn forms a discharge cell. This structure of the PDP 100 is an exemplary structure for a PDP, and so panels of other structures, to which the various driving waveforms to be described below can also be applied, can be used in accordance with the present invention.

The controller 200 receives an external video signal, and outputs an address electrode driving control signal 600, a sustain electrode driving control signal 700, and a scan electrode driving control signal 800. The controller 200 controls the plasma display device by dividing a frame into a plurality of subfields having respective brightness weight values. Each subfield may be expressed as operational changes according to time, which include a reset period, an address period, and a sustain period. In the PAL scheme, the controller 200 according to an exemplary embodiment of the present invention divides one frame into two groups, and disperses subfields having relatively greater weight values into the two different groups. In other words, the controller 200 disperses and allocates the two subfields having greatest weight values into the divided two groups.

The address electrode driver 300 receives the address electrode driving control signal 600 from the controller 200, and applies a display data signal for selecting discharge cells to be discharged to each address electrode.

The sustain electrode driver 400 receives the sustain electrode driving control signal 700 from the controller 200, and applies a driving voltage to the sustain electrode X.

The scan electrode driver 500 receives the scan electrode driving control signal 800 from the controller 200, and applies the driving voltage to the scan electrode Y.

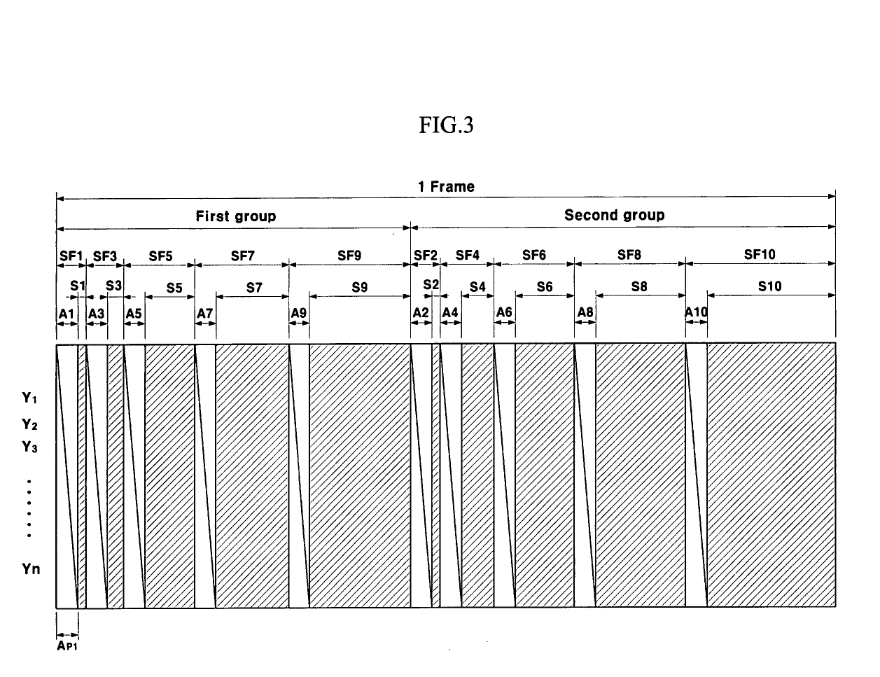

Referring to FIG. 3, the subfield arrangement in the PAL scheme according to the first exemplary embodiment of the present invention will be described in more detail. One frame is divided into first and second groups, and subfields having relatively greater weight values are dispersed into the two divided groups. In other words, the controller 200 disperses and allocates the two subfields having greatest weight values into the divided two groups. In FIG. 3, subfields SF1, SF3, SF5, SF7, and SF9 are allocated to the first group, and subfields SF2, SF4, SF6, SF8, and SF10 are allocated to the second group. Each of the subfields in the first group and the second group have a comparable address period Ap1. Since the PAL scheme has a time for one frame of 3.33 ms more than the NTSC scheme and therefore more subfields can be allocated, as in FIG. 3.

Moreover, because the subfields having larger weight values are dispersed into two groups, images shown to the human eye are changed every 10 ms. This time interval is hardly perceived by the human eye and so the flicker phenomenon is reduced.

Generally, a discharge, which is performed by applying a voltage between two electrodes, occurs with a delay after applying the voltage. In the address period, an address discharge should be performed within a width of a scan pulse and an address pulse. In other words, the address discharge is affected by a discharge delay time.

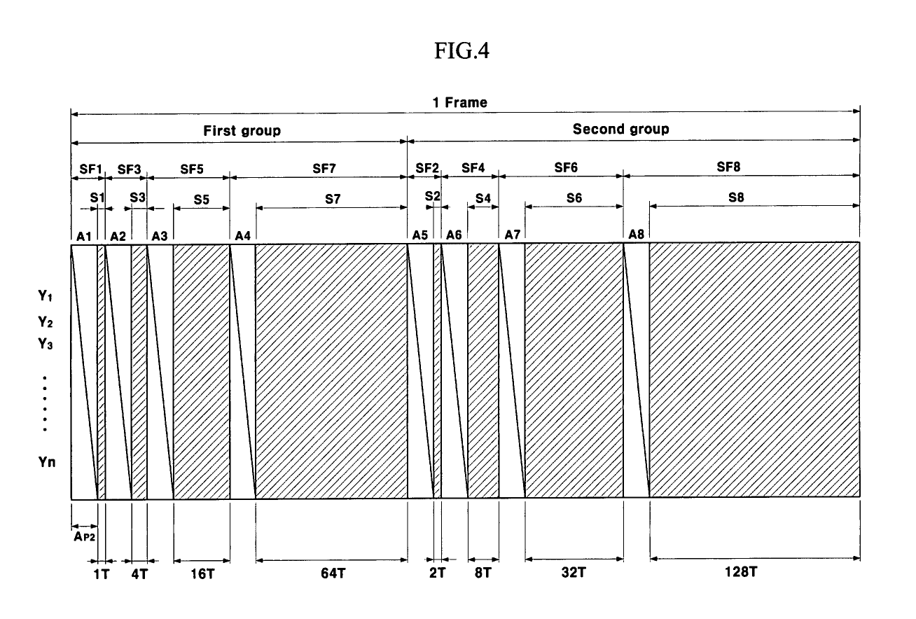

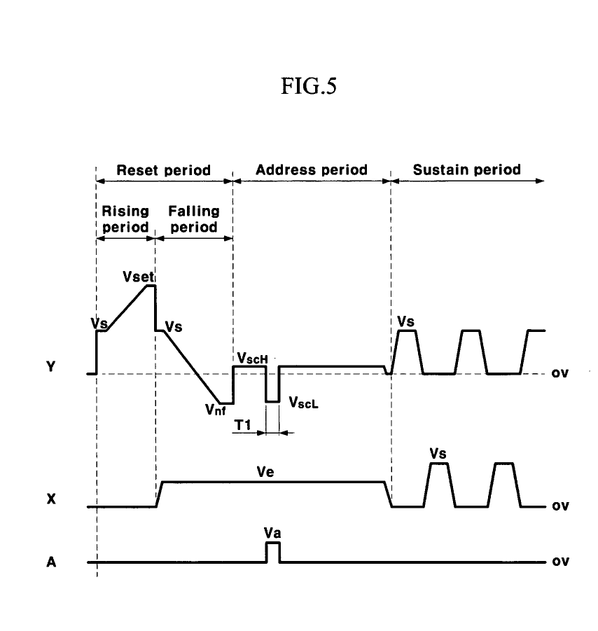

However, when arranging the subfields as shown in FIG. 3, a temporal distance from a previous subfield becomes relatively long. Therefore, priming particles, which are formed by a sustain discharge in the previous subfield, are extinguished with the lapse of time, and in the next subfield, the address discharge may hardly occur due to the delay of the address discharge. In the subfields having low weight values (i.e., subfield SF1, and subfield SF2), priming particles formed by the sustain discharge are not sufficient due to the small size of the sustain discharge. Sequentially, the delay of the address discharge becomes larger, and the address discharge hardly occurs. Hereinafter, referring to FIG. 4 and FIG. 5, an exemplary embodiment for stable address discharge will be described in more detail.

FIG. 4 illustrates a subfield arrangement in the PAL scheme according to the second exemplary embodiment of the present invention.

In the PAL scheme, the time for one frame is 20 ms, which is 3.33 ms more than that in the NTSC scheme. As shown in FIG. 4, according to the second exemplary embodiment of the present invention, this residual time 3.33 ms is allocated to the address period. In other words, an address period Ap2, according to the second exemplary embodiment, becomes longer than the address period Ap1, according to the first exemplary embodiment shown in FIG. 3. Thus, a longer address period allows an address pulse width to be longer, and so address discharge delay may be reduced.

FIG. 5 illustrates a driving waveform for the subfield shown in FIG. 4.

As shown in FIG. 5, during a rising period of the reset period, a voltage of the scan electrode Y is increased from Vs to Vset, while maintaining the sustain electrode X to be 0V. Then, a weak reset discharge occurs between the scan electrode Y and the address electrode A, and between the scan electrode Y and the sustain electrode X. Accordingly, negative (−) wall charges are formed on the scan electrode Y, and positive (+) wall charges are formed on the sustain electrode X and address electrode A.

During the falling period of the reset period, the voltage of the scan electrode Y is gradually decreased from the voltage Vs to a negative voltage Vnf while maintaining the address electrode A to be Ve. While the voltage of the scan electrode Y decreases, a weak discharge occurs between the scan electrode Y and the sustain electrode X, and between the scan electrode Y and the address electrode A. Accordingly, the negative (−) wall charges formed on the scan electrode Y and the positive (+) wall charges formed on the sustain electrode X and the address electrode A are eliminated, and the discharge cell is initialized.

Next, in the address period, the scan pulse having a voltage VscL and the address pulse having a voltage Va are respectively applied to the scan electrode Y and the address electrode A in order to select a cell to be turned on. The scan electrode Y, which is not selected, is biased by a voltage VscH that is higher than the voltage VscL, and a reference voltage is applied to the address electrode of the cell to be turned on. Then, the address discharge occurs due to the difference between the address voltage Va and the scan voltage VscL and the wall voltage formed in the address electrode A and the scan electrode Y. Accordingly, a positive (+) wall charge is formed on the scan electrode Y, and a negative (−) wall charge is formed on the sustain electrode X. A negative (−) wall charge is also formed on the address electrode A. Here, the scan pulse width T1 can be longer, and the address discharge can be performed within the address pulse width. Therefore, the address discharge may be performed stably.

Subsequently, in the sustain period, sustain discharge pulses having a high level voltage (Vs in FIG. 5) and a low level voltage (0V in FIG. 5) of opposite phase are applied to the scan electrode Y and the sustain electrode X. In more detail, when the voltage Vs is applied to the scan electrode Y, 0V is applied to the sustain electrode X, and when the voltage Vs is applied to the sustain electrode X, 0V is applied to the scan electrode Y. Since the wall voltage was formed between the scan electrode Y and the sustain electrode X by the address discharge in the address period, a discharge occurs between the scan electrode Y and the sustain electrode X by the wall voltage and the voltage Vs.

Afterwards, the sustain discharge pulse is applied to the scan electrode Y and the sustain electrode X as frequently as the number corresponding to a weight value of the subfield.

According to the exemplary embodiments of the present invention, when driving a plasma display device in the PAL scheme, the flicker may be reduced, and a stable address operation may be performed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a plasma display having a plurality of first electrodes, a plurality of second electrodes, and a plurality of third electrodes formed in a direction crossing the first electrodes and the second electrodes, and having a vertical synchronization signal of a second frequency lower than a first frequency, the method driving the plasma display panel by a frame divided into a plurality of subfields having respective weight values, the method comprising, in an address period:
sequentially applying a scan pulse to a first electrode; and
applying an address pulse to a third electrode of a discharge cell to be turned on among the plurality of discharge cells formed on the first electrode to which the scan pulse is applied,
wherein at least a part of a difference between one frame time according to the first frequency and that according to the second frequency is allocated to an address pulse width.

2. The driving method of claim 1, wherein the first frequency is a vertical synchronization frequency of the National Television System Committee (NTSC) format and the second frequency is a vertical synchronization frequency of the Phase Alternate Line (PAL) format.

3. The driving method of claim 2, wherein the one frame is divided into at least a first group and a second group and wherein the plurality of subfields are alternatingly distributed to the first group and the second group in an order of weight value magnitude.

4. A plasma display device comprising:
a plasma display panel having a plurality of first electrodes, a plurality of second electrodes, and a plurality of third electrodes formed in a direction crossing the first electrodes and the second electrodes;
a controller for dividing a frame into a plurality of subfields having a reset period, an address period, and a sustain period, and in an extrinsic vertical synchronization signal of a second frequency lower than a first frequency, allocating at least a part of a difference between one frame time according to the first frequency and one frame time according to the second frequency to a width of an address pulse applied to the third electrode of a discharge cell to be selected in the address period;
a driving circuit for respectively applying a scan pulse and the address pulse to the first electrode and the third electrode of the discharge cell to be selected in the address period.

5. The plasma display device of claim 4, wherein the first frequency is a vertical synchronization frequency of the National Television System Committee (NTSC) format and the second frequency is a vertical synchronization frequency of the Phase Alternate Line (PAL) format.

6. The plasma display device of claim 5, wherein the controller divides the one frame into a first group and a second group and alternatingly distributes the plurality of subfields to the first group and the second group in an order of weight value magnitude.
